(19) United States
(12) Patent Application Publication
(10) Pub. No.: US 2024/0338641 A1
(43) Pub. Date: Oct. 10, 2024

(54) CONSUMABLE AUTOMATIC DELIVERY SYSTEM THAT ENABLES PROPER USE OF CONSUMABLE AUTOMATIC DELIVERY SERVICE, METHOD OF CONTROLLING SAME, AND STORAGE MEDIUM

(71) Applicant: CANON KABUSHIKI KAISHA, Tokyo (JP)

(72) Inventor: AKIHIRO MORIYA, Chiba (JP)

(21) Appl. No.: 18/623,908

(22) Filed: Apr. 1, 2024

(30) Foreign Application Priority Data
Apr. 4, 2023 (JP) 2023-060949

(51) Int. Cl. G06Q 10/083; G06K 15/00

(52) U.S. Cl. CPC G06Q 10/083; G06K 15/002; G06K 15/407

(57) ABSTRACT

A consumable automatic delivery system including a device that requires replacement of consumables and a subscription management server that executes automatic order processing for a consumable upon receipt of an order trigger from a resource server that manages the device, in which a consumable ordered by executing the automatic order processing is delivered to a user, the system includes a user interface unit that changes a setting of a region, a delivery setting unit that sets automatic delivery of consumables to an activated state or a deactivated state, and a switching unit that switches, in a case where the setting of the region is changed by the user interface to a state in which automatic delivery of consumables has been set to the activated state by the delivery setting unit, the activated state to the deactivated state.

### BACKGROUND

### Field of the Disclosure

The present disclosure relates to a consumable automatic delivery system that enables proper use of a consumable automatic delivery service, a method of controlling the same, and a storage medium.

### Description of the Related Art

An image forming apparatus is widely known for recording information such as text and images on a sheet-type recording medium, such as a paper sheet or a film, using an electrophotographic method. This image forming apparatus uses toner or ink to form an image on a recording medium. Therefore, a user needs to purchase and replace a cartridge storing such consumable or a consumable device, or a process cartridge formed by integrating a charger, a photosensitive drum, and a developing device, as required. To reduce user's time and effort for purchasing these consumables, there are known automatic order systems for automatically ordering consumables to a predetermined order destination. In the automatic order system, an image forming apparatus is a client apparatus, and a resource server executes processing for automatically ordering consumables based on information transmitted from the client apparatus.

In such an automatic order system, first, an administrator performs an operation of subscribing to the automatic order service. After performing the operation, the administrator registers (activates) the client apparatus in a resource server that manages the automatic order service. After that, when a user performs printing by using the client apparatus, consumable information indicating a consumed state of a consumable is transmitted from the client apparatus to the resource server. Then, the resource server executes automatic order processing for the user based on the consumable information transmitted from the client apparatus.

Incidentally, in these days, a law has been made for defining countries and regions where client apparatuses that transmit data and resource servers that receive data physically exist (hereinafter each also referred to as the region) from the viewpoint of personal information protection/confidential information protection. For this reason, a region of a resource server tends to be added year by year, and it is assumed that the automatic order service for consumables is provided across a plurality of regions. Japanese Laid-Open Patent Publication (Kokai) No. 2019-61580 discloses a technique for identifying an appropriate end point according to region information designated by a client apparatus (device), and an end point is identified based on region information designated by a client apparatus (device).

However, although determination of the end point (such as a URL) depends on the region information set by the client apparatus, there is a possibility that the region information is also used for a system setting other than that of the consumable automatic order service in the client apparatus. Therefore, in a case where the setting of the region information is changed by a user, this setting changes to various settings can affect the consumable automatic order service. Specifically, in a case where the user has erroneously set the region setting, the client apparatus can be connected to a resource server at an end point different from the country/region where the user resides.

For example, in a case where a user residing in Canada sets the setting of delivery of toner as a consumable of a printer to on (activated state) in a state in which USA has been set as the region, data is transmitted to a server of a wrong region, and hence the toner is not delivered. What is more, the region of the connection destination server is finally determined at the time of setting the toner delivery setting to on, and hence even when the region setting is changed later, the server as the connection destination is not changed. In this case, the user cannot properly receive the consumable automatic order service. For this reason, the user also requires to properly change the region setting of the consumable automatic order service.

### SUMMARY

The present disclosure provides a consumable automatic delivery system that enables a user to properly use a consumable automatic delivery service, a method of controlling the same, and a storage medium.

According to an aspect of the present disclosure, there is provided a consumable automatic delivery system including a device that requires replacement of consumables and a subscription management server that executes automatic order processing for a consumable upon receipt of an order trigger from a resource server that manages the device, in which a consumable ordered by executing the automatic order processing is delivered to a user, the system includes a user interface unit that changes a setting of a region, a delivery setting unit that sets automatic delivery of consumables to an activated state or a deactivated state, and a switching unit that switches, in a case where the setting of the region is changed by the user interface to a state in which automatic delivery of consumables has been set to the activated state by the delivery setting unit, the activated state to the deactivated state.

According to the present disclosure, it is possible to obtain an advantageous effect that a user can properly use the consumable automatic delivery service.

Further features of the present disclosure will become apparent from the following description of exemplary embodiments with reference to the attached drawings.

### BRIEF DESCRIPTION OF THE DRAWINGS

FIG. 1A is a block diagram of a hardware configuration of an image forming apparatus.

FIG. 1B is a block diagram of a hardware configuration of each of servers.

FIG. 2 is a functional block diagram of the image forming apparatus (MFP).

FIGS. 3A to 3F are respective functional block diagrams of the servers.

FIG. 4 is a schematic block diagram showing network connection of an image processing system.

FIGS. 5A and 5B are explanatory diagrams each showing an example of a registration screen displayed on a console section.

FIG. 6 is an explanatory diagram showing an example of a region setting screen displayed on the console section.

FIG. 7 is an explanatory diagram of a relationship between a region and an end point.

FIG. 8 is a sequence diagram of a communication process performed between the MFP and a variety of servers.

FIG. 9 is a sequence diagram of a state acquisition process that is periodically executed.

FIG. 10 is a flowchart of a process performed in a case where a region setting is changed.

FIG. 11 is a flowchart of a process performed according to validity of connection destination information of a resource server.

FIGS. 12A to 12C are explanatory diagrams each showing an update display displayed in a case where the region setting has been changed.

### DESCRIPTION OF THE EMBODIMENTS

The present disclosure will now be described in detail below with reference to the accompanying drawings showing embodiments thereof. However, the following description of configurations of the embodiments is given only by way of example, and is by no means intended to limit the scope of the present disclosure.

Note that in the embodiments of the present disclosure, as an image forming apparatus, a multifunction peripheral (MFP) having a print function, a scan function, a fax function, and the like, will be described by way of example. First, a first embodiment of the present disclosure will be described.

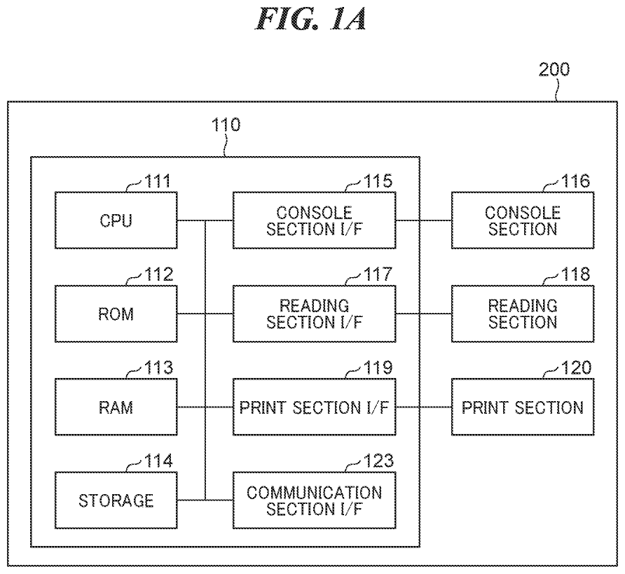

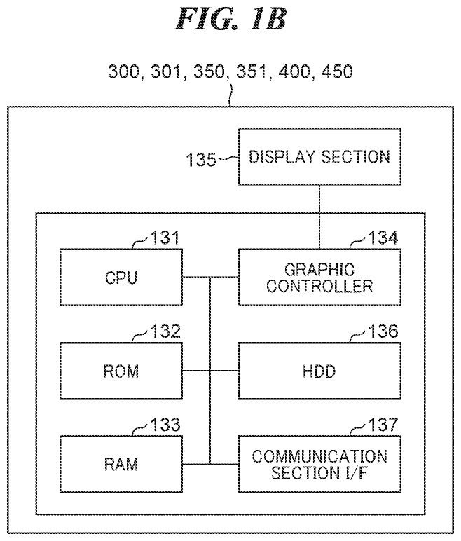

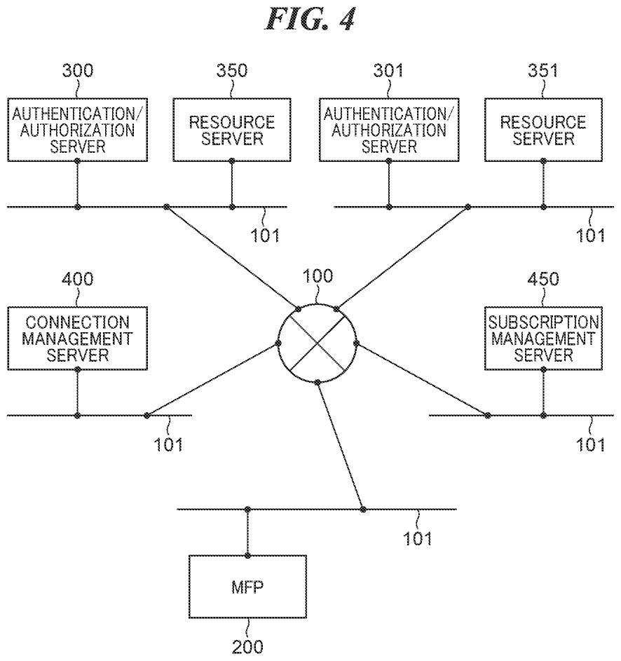

FIG. 1A is a block diagram of a hardware configuration of the MFP, denoted by reference numeral 200, which is the image forming apparatus of the embodiment of the present disclosure, and FIG. 1B is a block diagram of a hardware configuration of a server. Note that although an information processing system of the present embodiment shows an example including the MFP 200, and servers 300, 301, 350, 351, 400, and 450 (see FIG. 4), this is not limitative. For example, only the MFP 200 can be regarded as the image processing system.

First, the hardware configuration of the MFP 200 will be described with reference to FIG. 1A. The MFP 200 is a multifunction peripheral having a variety of functions, including a reading function of reading an image on a sheet and a print function of printing an image on a sheet. Further, the MFP 200 is also equipped with a file transmission function of transmitting a file of image data to an external apparatus. Although in the present embodiment, the MFP 200 will be described as an example of the image forming apparatus, the image forming apparatus can be a printing apparatus, such as a printer, which is not equipped with the reading function or can be an image reading apparatus, such as a scanner, which is not equipped with the print function.

The MFP 200 includes a controller 110, a console section (a user interface) 116, a reading section 118, and a print section 120. The controller 110 includes a Central Processing Unit (CPU) 111, a Read Only Memory (ROM) 112, a Random Access Memory (RAM) 113, a storage 114, a console section interface (I/F) 115, a reading section I/F 117, a print section I/F 119, and a communication section I/F 123. The components of the controller 110 are configured to be capable of transmitting and receiving necessary information to and from each other.

The controller 110 including the CPU 111 controls the overall operation of the MFP 200. The CPU 111 loads a control program stored in the ROM 112 or the storage 114 into the RAM 113 and executes the loaded control program. Thus, a variety of controls including a reading control, a print control, and a communication control, are performed. The ROM 112 stores control programs which can be executed by the CPU 111, in a nonvolatile state. The RAM 113 is a main storage memory for the CPU 111. The RAM 113 functions as a work area and a temporary storage area for loading control programs stored in the ROM 112 and the storage 114.

The storage 114 stores print data, image data, a variety programs, and a variety of setting information. Note that the MFP 200 of the present embodiment is configured such that a single CPU 111 executes processing operations, described hereinafter, by using a single memory (RAM 113). However, any other form can be employed. For example, the processing operations, described hereinafter, can be executed by operating a plurality of CPUs, RAMs, ROMs, and storages in cooperation. Further, part of the processing operations can be executed by a hardware circuit, such as an Application Specific Integrated Circuit (ASIC) and a Field-Programmable Gate Array (FPGA).

Further, the console section I/F 115 is an interface for electrically connecting between the console section 116 and the controller 110. The reading section interface 117 is an interface for electrically connecting between the reading section 118 and the controller 110. The reading section 118 reads an image on a sheet and generates image data. The image data read by the reading section 118 is transmitted to an external apparatus and is printed on a sheet. Further, the reading section 118 is also capable of reading a plurality of original sheets by feeding and reading sheets placed on an original feeder (not shown). Note that in the case of the MFP 200, the console section 116 also functions as a display section, not shown, on which necessary information is displayed, and, for example, necessary setting operations can be performed with respect to the MFP 200 by a touch operation or the like on a displayed item.

The print section I/F 119 is an interface for electrically connecting between the print section 120 and the controller 110. Image data to be printed is transferred from the controller 110 to the print section 120 via the print section I/F 119. The print section 120 receives a control command and image data to be printed via the controller 110 and prints an image based on the received image data on a sheet. The printing method used by the print section 120 can be an electrophotographic method or an inkjet method. In a case where the electrophotographic method is used, an image is formed by forming an electrostatic latent image on a photosensitive member, developing the electrostatic latent image with toner, transferring the developed toner image onto a sheet, and fixing the transferred toner image.

On the other hand, in a case where the inkjet method is used, an image is printed on a sheet by ejecting ink. Consumables used for printing, including a toner cartridge and an ink cartridge used by the print section 120, are removably attached inside the MFP 200. A user can replenish a consumable by cartridge replacement. Note that the CPU 111 acquires a remaining amount of each consumable necessary for printing at a periodic timing, at a timing of printing of each page, and at a timing of attachment of a cartridge, and holds information on the acquired toner remaining amount, in the RAM 113. Further, when a cartridge is attached, the CPU 111 stores the model number of the attached cartridge in the RAM 113 or the storage 114.

Further, the controller 110 is connected to a Local Area Network (LAN) 101 (see FIG. 4) via the communication I/F 123. The controller 110 receives print data and a variety of information and transmits information on consumables, such as information on the toner remaining amount or information on the model number of the cartridge, which is stored in the RAM 113 or the storage 114, via the communication I/F 123 and the LAN 101. The print data received via the communication I/F 123 is analyzed by a software module (Page Description Language (PDL) analysis section, not shown) for analyzing print data stored in the storage 114 or the ROM 112. The PDL analysis section generates data to be printed by the print section 120 based on a print data item each expressed by one of a variety of types of page description languages.

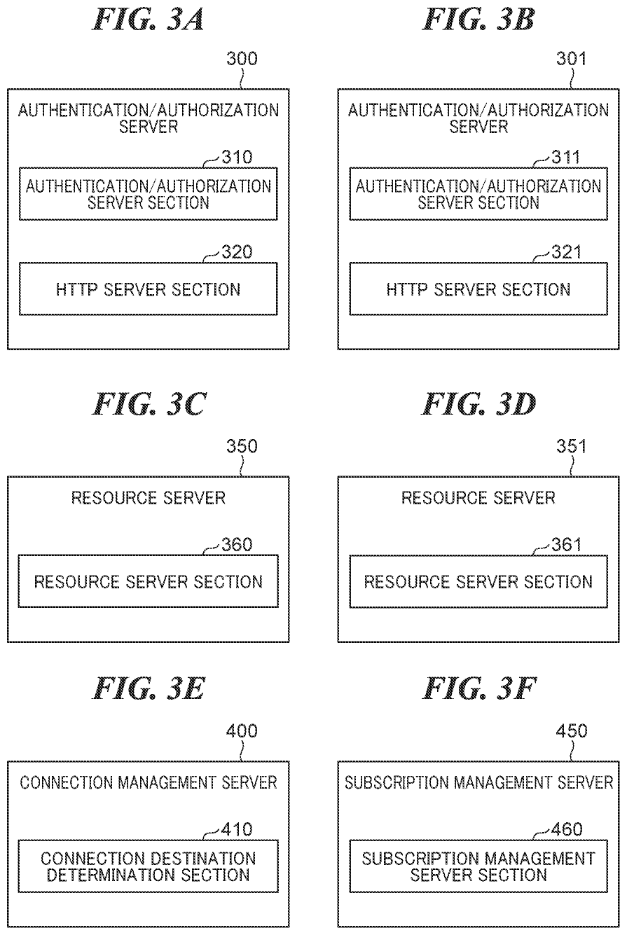

Next, the variety of servers (300, 301, 350, 351, 400, and 450) will be described with reference to FIG. 1B. Note that, as shown in FIG. 3A to 3F, the variety of servers include the authentication/authorization servers 300 and 301, the resource servers 350 and 351, the connection management server 400, and the subscription management server 450. Note that in a case where both of the authentication/authorization server 300 and the authentication/authorization server 301 can be used, the authentication/authorization server is described as the authentication/authorization server 300/301. Similarly, in a case where both of the resource server 350 and the resource server 351 can be used, the resource server is described as the resource server 350/351. Further, the variety of servers have the same hardware configuration, and hence the following description will be given of the authentication/authorization server 300, by way of example.

The authentication/authorization server 300 includes a CPU 131, a ROM 132, a RAM 133, a graphic controller 134, a display section 135, and a Hard Disk Drive (HDD) 136. Further, the authentication/authorization server 300 includes a communication section I/F 137, and these components are connected via a bus in a state in which they can transmit and receive necessary information to and from each other.

The CPU 131 is a processor and performs centralized control of the authentication/authorization server 300. Note that any other processor, such as a digital signal processor (DSP), can be used in place of the CPU 131. The CPU 131 reads and loads an operation program stored in the ROM 132 or the HDD 136 into the RAM 133 and executes the loaded operation program. With this, a variety of necessary processing operations are executed. The ROM 132 stores a system program used for controlling the authentication/authorization server 300, other operation programs, and so forth, in a nonvolatile state.

The graphic controller 134 generates a screen to be displayed on the display section 135. With this, the display section 135 displays a desired screen. The HDD 136 is a storage device having a storage area and stores application programs and the like for executing a variety of processing operations. The HDD 136 is an example of the storage device, and the storage device can be implemented not only by the HDD, but also by a Solid State Drive (SSD) or the like. The communication section I/F 137 is an interface for connecting a variety of devices to the authentication/authorization server 300. For example, input and output devices, such as a display, a keyboard, and a mouse, can be connected to the authentication/authorization server 300 via the communication I/F 137. Further, the communication section I/F 137 performs communication of necessary information with the MFP 200 and the like via the LAN 101 under the control of the CPU 131.

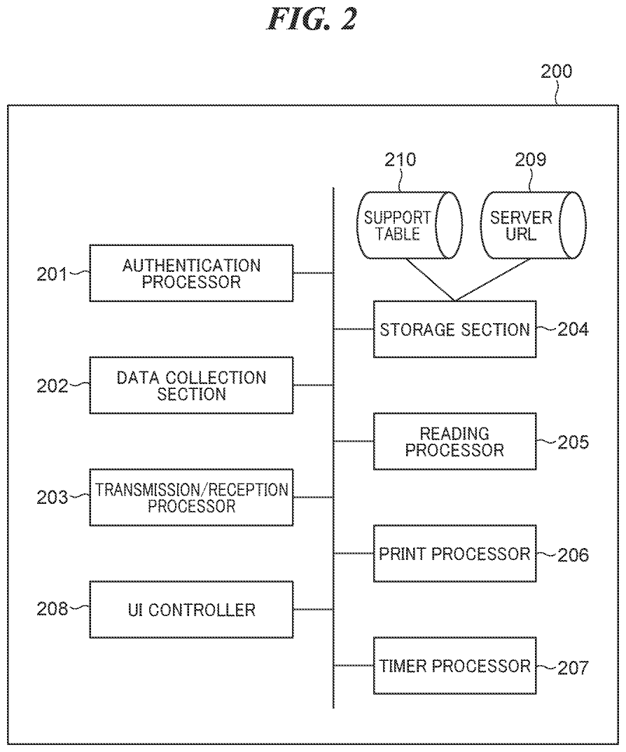

FIG. 2 is a functional block diagram of the MFP 200 of the embodiment of the present disclosure. The functional sections shown in FIG. 2 are realized by the CPU 111 of the MFP 200 executing control programs. The functional sections shown in FIG. 2 each realize a desired operation by using the hardware shown in FIG. 1A. The MFP 200 includes an authentication processor 201, a data collection section 202, a transmission/reception processor 203, a storage section 204, a reading processor 205, a print processor 206, a timer processor 207, and a user interface (UI) controller 208.

The authentication processor 201 controls the communication I/F 123, appearing in FIG. 1A, to communicate with the connection management server 400 and the authentication/authorization server 300/301 via the LAN 101. The data collection section 202 collects internal data in the MFP 200. The transmission/reception processor 203 controls the communication I/F 123, appearing in FIG. 1A, to control connection to the LAN, disconnection from the LAN, and communication via the LAN, and transmit data collected by the data collection section 202 to the resource server 350/351.

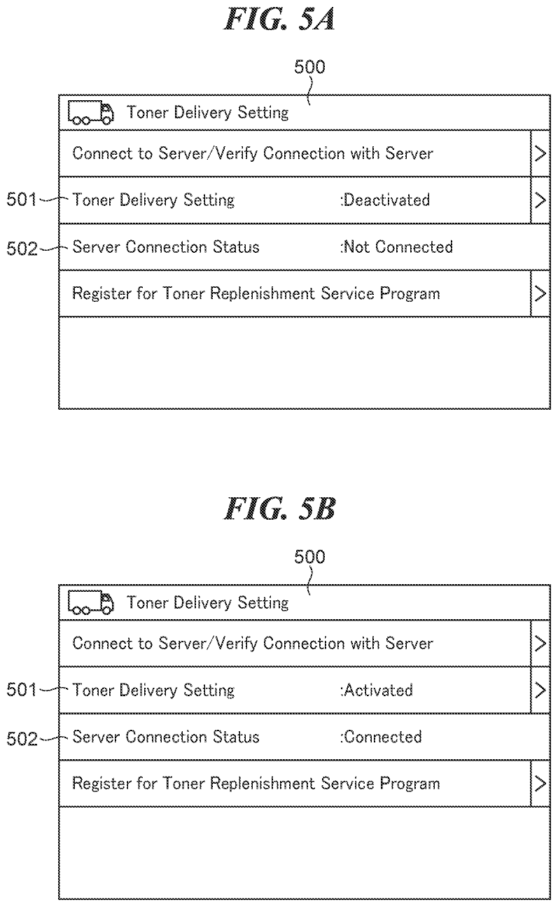

The UI controller 208 controls the console section 116 (see FIG. 1A) via the console section I/F 115. Specifically, the UI controller 208 provides a user notification to the console section 116, displays a variety of selection menus and so forth, receives an operation performed by a user on the console section 116, transmits contents of the received operation to another functional section, and performs a variety of controls and a variety of processing operations associated with items set on the display screen. In the present embodiment, the UI controller 208 receives a user operation on screens shown in FIGS. 5A and 5B (for device registration to the consumable order service), for example, and performs the control. The storage section 204 stores, according to an instruction from another functional section, designated data in the ROM 112, the RAM 113, or the storage 114, appearing in FIG. 1A, and reads out stored data.

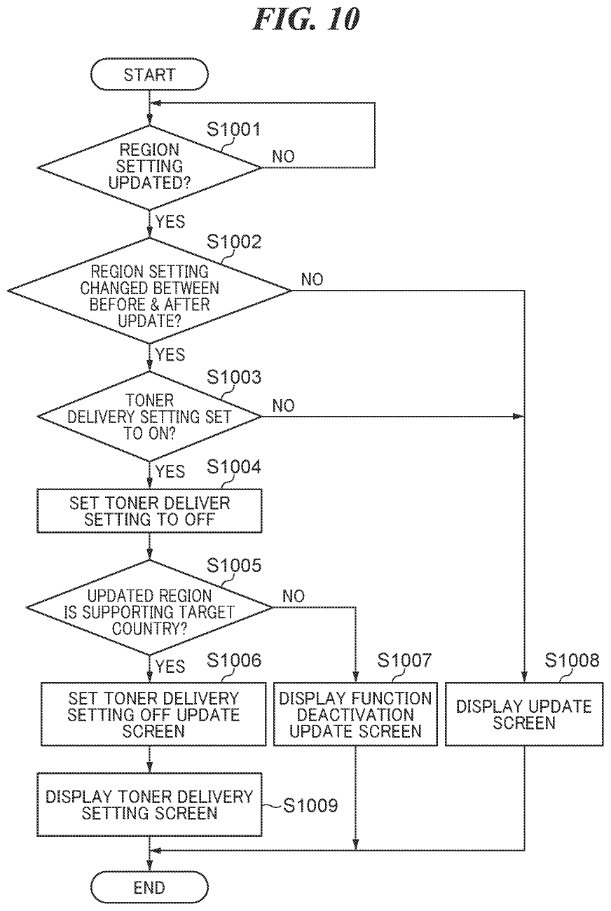

Further, as described hereinafter, the storage section 204 also executes, for example, processing for comparing stored contents with another item, processing for determining whether or not there is a change in a setting item by an operation of the UI controller 208, and processing for grasping an item set by an operation of the UI controller 208. That is, as shown, for example, in FIG. 10, the storage section 204 can not only write/read data, but also execute a variety of processing operations associated with a setting item set by an operation of the UI controller 208. In the present embodiment, as shown in FIG. 2, the storage section 204 can refer to a server uniform resource locator (URL) 209 which is a connection destination URL stored, for example, in the storage 114 of the MFP 200, and a support table 210 storing contents of a consumable automatic delivery service.

The reading processor 205 controls the operation of the reading section 118 (see FIG. 1A) by sending a variety of predetermined commands to the reading section 118 and receiving a state of the reading section 118, via the reading section I/F 117. The print processor 206 controls the operation of the print section 120 (see FIG. 1A) by sending a variety of predetermined commands to the print section 120 and receiving a state of the print section 120 via the print section I/F 119. The timer processor 207 determines whether or not a predetermined time period has elapsed in accordance with an operation of a time count processing function, which is performed by the CPU 111.

FIGS. 3A to 3F are respective functional block diagrams of the servers. 300, 301, 350, 351, 400, and 450. The authentication/authorization server 301 shown in FIG. 3B has the same function as the authentication/authorization server 300 shown in FIG. 3A, and the resource server 351 shown in FIG. 3D has the same function as the resource server 350 shown in FIG. 3C, and hence the authentication/authorization server 300 and the resource server 350 will be describe with reference to FIGS. 3A and 3C. Note that description of server sections 311, 321, and 361 appearing in FIGS. 3B and 3D will be omitted.

The authentication/authorization server 300 has an authentication/authorization server section 310 and an HTTP server section 320. Here, the HTTP server section 320 is connected to the MFP 200 via a Wide Area Network (WAN) 100 and has a function of performing HTTP communication with the communication section I/F 123 of the MFP 200. Further, the HTTP server section 320 is capable of performing communication using Secure Socket Layer (SSL)/Transport Layer Security (TLS) and has a certificate store, not shown.

The authentication/authorization server section 310 has a function of receiving a request from the communication section I/F 123 of the MFP 200 and transmitting a result of the received request as a response thereto via the HTTP server section 320. Specifically, the HTTP server section 320 receives a device authentication request from the communication section I/F 123 of the MFP 200. The device authentication request includes a serial number of an image forming apparatus. Then, the authentication/authorization server section 310 generates an authentication token associated with device information of a device on which authentication has been successfully performed and notifies the authentication token to the communication section I/F 123 of the MFP 200. The above-mentioned device information refers to the serial number of the image forming apparatus, which is included in the device authentication request.

Here, the authentication token refers to a token for indicating that a device has logged in the authentication/authorization server 300, or a token for verifying whether or not a device has been authenticated by the authentication/authorization server 300. By using the authentication token, the authentication/authorization server 300 can identify a device. Further, the authentication/authorization server section 310 can be configured to hold a secret key for adding signature information to an authorization token. In this case, the authentication/authorization server section 310 adds the signature information to the authorization token by using the secret key, and issues the authorization token having the signature information added thereto to the MFP 200. Thus, the authentication/authorization server 300 has the authentication function and the authorization function.

The resource server 350 has a resource server section 360. The resource server section 360 has a function of disclosing an Application Programing Interface (API) for providing a Web service. The API to be disclosed can be used for API cooperation for linking, for example, data between servers or between the MFP 200 and servers. The connection management server 400 has a connection destination determination section 410. The connection destination determination section 410 has a function of receiving a request from the communication section I/F 123 of the MFP 200 and notifying an end point of a connection destination thereto in response to the request received from the communication section I/F 123.

The subscription management server 450 has a subscription management server section 460. The subscription management server section 460 has a function of managing information of subscription to the consumable automatic delivery from a user. The subscription management server section 460 notifies the subscription information of the user to the resource server 350. The subscription information refers to information indicating whether or not each image forming apparatus has made a contract for using the consumable automatic delivery.

Note that the resource server 350, the connection management server 400, and the subscription management server 450 can be each configured, similarly to the authentication/authorization server 300, to include an HTTP server section, and transmit and receive information to and from an external apparatus via the HTTP server section.

Next, the network configuration of the image processing system in the embodiment of the present disclosure will be described with reference to FIG. 4. The WAN 100 positioned in the center in FIG. 4 is constructed by the World Wide Web (WWW) system. The WAN 100 and the devices 200 to 450 are connected via the LAN 101. Here, the MFP 200 and the servers 300, 301, 350, 351, 400, and 450 are each also referred to as a device.

The authentication/authorization server 300/301 is a server for realizing the Open Authorization (OAuth) 2.0 protocol and performs processing operations, for example, for receiving an authentication request, and issuing and managing an authorization code. Note that the OAuth 2.0 protocol is an HTTP protocol focusing on the WEB service. In a network connection form shown in FIG. 4, the authentication/authorization server 300 and the resource server 350 are connected via the LAN 101, and similarly, the authentication/authorization server 301 and the resource server 351 are connected via the LAN 101. However, the network connection form is not limited to this, but for example, the authentication/authorization server 300/301 and the resource server 350/351 can be connected via the WAN 100.

Further, the authentication/authorization server 300/301 can be configured to be connected to a database server, not shown, via the LAN 101, and store data used by the authentication/authorization server 300/301 to realize the functions thereof, in the database server. Further, in FIG. 4, the authentication/authorization server 300 and the resource server 350, and the authentication/authorization server 301 and the resource server 351 are described as separate servers. However, the functions of an authentication/authorization server and a resource server can be configured to be provided on an identical server.

Note that the resource server 350 and the authentication/authorization server 300 (or the resource server 351 and the authentication/authorization server 301) are not necessarily required to be located within an identical region or an identical system. Various location forms can be employed insofar as the resource server 350 can inquire an authorization token issued by the authentication/authorization server 300. Further, the resource server 350 can be configured to verify signature information received together with the authorization token.

The connection management server 400 is a server that manages end points (such as URLs) and manages the end points of the authentication/authorization server 300/301, and the resource server 350/351. The connection management server 400 can be connected to a database server, not shown, via the LAN 101, and store URL data of the end points in the database server.

The subscription management server 450 is a server that manages automatic order for consumables and executes automatic order upon receipt of an order trigger from the resource server 350. In the present embodiment, the identical subscription management server 450 is connected to the plurality of resource servers. However, a different subscription management server 450 can be connected to each of the resource servers 350 and 35.

The MFP 200 is connected to the network in a state enabled to acquire an end point from the connection management server 400, request authentication to the authentication/authorization server 300/301, and transmit consumables information to the resource server 350/351 via the LAN 101.

FIGS. 5A and 5B are explanatory diagrams each showing an example of a device registration screen. A toner delivery-setting screen 500 shown in FIG. 5A is displayed on the console section 116 of the MFP 200, and the display of this screen is controlled by the UI controller 208. The toner delivery-setting screen 500 is a screen used by a user to set toner delivery. By selection of a toner delivery setting 501 by the user, the toner delivery setting can be changed. In the illustrated example in FIG. 5, on the toner delivery-setting screen 500, the toner delivery setting 501 is set to deactivated: Disabled, a server connection status 502 is set to Not Connected. The toner delivery setting 501 indicates whether or not the consumable automatic delivery function of the image forming apparatus is used. In a case where the toner delivery setting 501 is set to Deactivated, the consumable automatic delivery function of the image forming apparatus is not used. The server connection status 502 indicates whether or not to notify the resource server when an event is generated in the image forming apparatus. In a case where the server connection status 502 indicates Not Connected, even when an event is generated in the image forming apparatus, the event is not notified to the server.

On an example, shown in FIG. 5B, of the toner delivery setting screen 501, the toner delivery setting 501 is set to Activated (operation of a delivery setting section), and a server connection status 512 is set to Connected (operation of a display notification section). Note that even when the toner delivery setting 511 is set to Activated, in a case where communication for device registration has failed, it is preferable to display and notify the status of connection, for example, to the resource server 350 as Not Connected to enable the user to be visually notified.

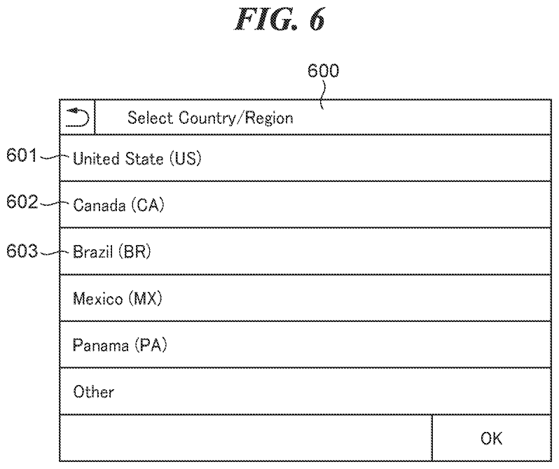

FIG. 6 is an explanatory diagram showing an example of a screen for setting a region. A region setting screen 600 is displayed on the console section 116, and the display of this screen is controlled by the UI controller 208. The region setting screen 600 is a screen used by a user to set a region. On a screen for selecting a region, regions of United State (US) 601, Canada (CA) 602, Brazil (BR) 603, and so forth, can be selected. The region setting can be made from a device setting screen. The region is set not only at a desired timing, but also when an image forming apparatus is installed.

Although in the present embodiment, a list of regions which can be set is stored and managed in the ROM 112 or the storage 114, the list of regions can be acquired from an external server, for selection of a region. Further, the regions which can be selected on the region setting screen 600 are not necessarily required to be fixed, but, for example, the selectable regions can be limited or increased, based on a model adapted to a region where the MFP 200 is sold.

With the region setting screen 600, the region setting has an influence on the end points of the authentication/authorization server 300 and the resource server 350, which are accessed from the MFP 200. Further, the region setting has an influence on default settings of the facsimile transmission/reception function and a default sheet size setting of a sheet feed cassette in the print function. For example, in a case where the region is set to US, the default sheet size of the sheet feed cassette is set to Letter. On the other hand, in a case where the region is set to Other, the default sheet size of the sheet feed cassette is set to A4. Thus, the setting of the device is changed according to a set region. Further, the region setting has an influence on an image adjustment mode in an adjustment/maintenance function. Specifically, an image adjustment mode adapted to characteristics of paper used in each country/region is set. Note that the settings of the network and the security can be switched according to the region setting.

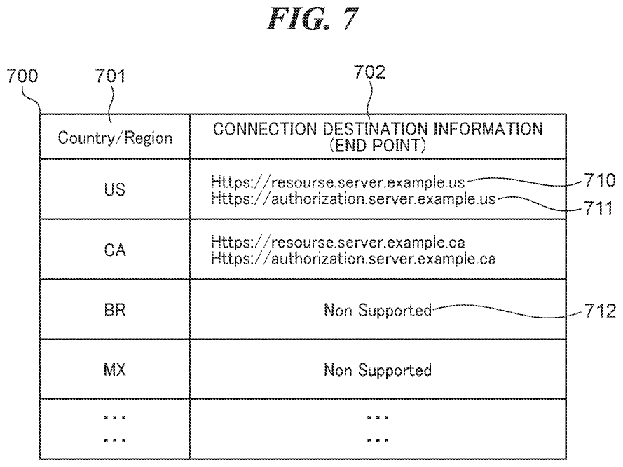

FIG. 7 is an explanatory diagram of a relationship between the region and the end point. An end point management table 700 is stored and managed in the HDD 166 of the connection management server 400. The end point management table 700 stores Country/Region 701 and connection destination information 702 in a state associated with each other. The Country/Region 701 represents a region type. Although in the illustrated example in FIG. 7, country names are stored, region names can be stored. The Country/Region 701 in FIG. 7 corresponds to the Country/Region which can be set on the region setting screen 600 shown in FIG. 6. The connection destination information (end point) 702 represents end points (URLs) of servers associated with the Country/Region 701. As the end point, a URL of a resource server and a URL of an authentication/authorization server, which are to be used in a case where each region is set, are set.

For example, a resource server URL 710 indicates a resource server end point used in a case where the Country/Region 701 is set to US. Similarly, an authentication/authorization server URL 711 indicates an authentication/authorization server end point used in a case where the Country/Region 701 is set to US. In a case where the Country/Region 701 is set to Brazil (BR), the connection destination information 702 is set to non-supported information 712, indicated by Non Supported, which expresses that the region is not supported by the automatic delivery service.

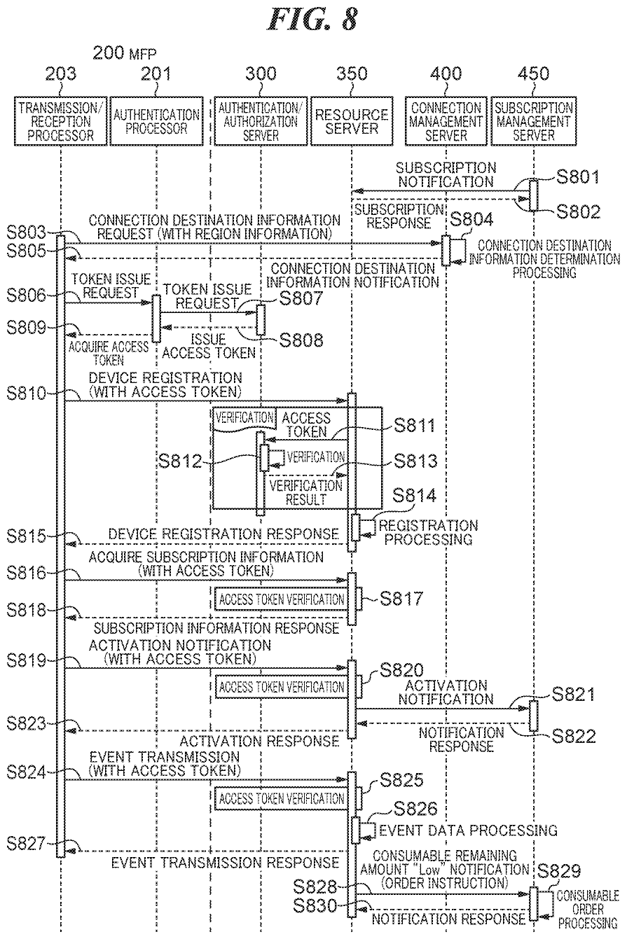

FIG. 8 is a sequence diagram of communication performed between the MFP 200 and the variety of servers. Here, a process from registration including acquisition of connection destination information to transmission of consumables information will be described. The operations (steps) of the sequence are realized by the CPU 111 loading a control program stored in the ROM 112 or the storage 114 into the RAM 113 and executing the loaded control program. Note that basically in FIG. 8, a lateral solid line represents an operation of a request, and a lateral dot line represents an operation of a response.

When a user accesses the subscription management server from a Web browser of a terminal (such as a PC, a tablet terminal, or a smartphone), not shown, and transmits information necessary for the contract of the consumable automatic delivery service, the following process is started. More specifically, the user accesses the subscription management server from the terminal. Then, the user transmits a serial number of an image forming apparatus as a target of the consumable automatic delivery service to the subscription management server. In doing this, the user can also register information associated with a delivery destination of the consumables in the subscription management server. In a step S801, the subscription management server 450 transmits a subscription notification to the resource server 350. The subscription refers to that the user has subscribed to the contract of the consumable automatic delivery service via the Web browser of the terminal (such as a PC, a tablet terminal, or a smartphone), not shown. The subscription notification notified in the step S801 includes the serial number of the image forming apparatus as the target of the consumable automatic delivery service. The resource server 350 stores the serial number included in the subscription notification as information on the image forming apparatus which is the target of the consumable automatic delivery service. When the subscription has been performed, the subscription management server 450 manages the subscription information.

Note that FIG. 8 shows a case in which the subscription notification from the user has been performed in advance. However, the subscription notification from the user can be performed after device registration. Next, in a step S802, the resource server 350 transmits a response indicating that the subscription notification has been received, to the subscription management server 450.

Next, a step S803 is started by the CPU 111 detecting that the user has set the toner delivery setting 501 to on, as a trigger, on the toner delivery-setting screen 500, shown in FIG. 5, which is displayed by the UI controller 208 of the MFP 200. The transmission/reception processor 203 transmits a connection destination information request to the connection management server 400. When transmitting the connection destination information request, the region information set on the region setting screen 600 shown in FIG. 6 is added to the request so as to perform communication.

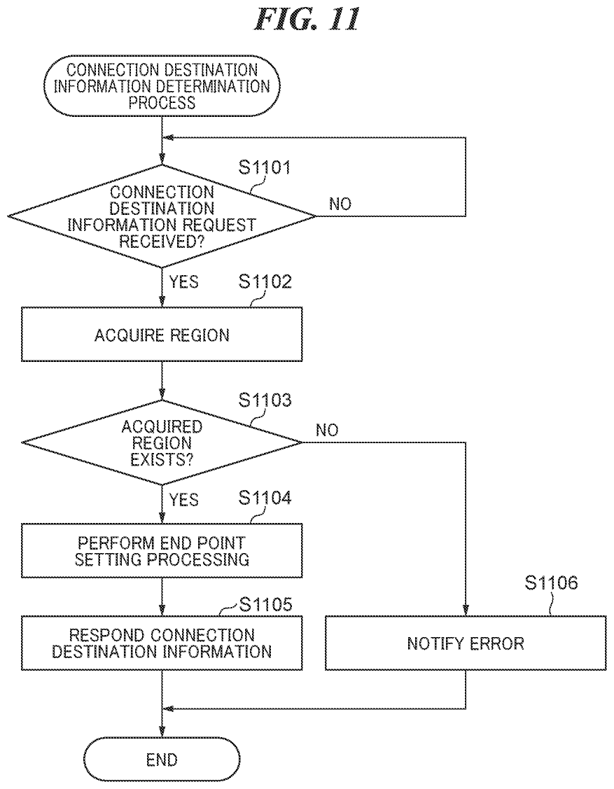

Next, in a step S804, the connection management server 400 performs a process according to the validity of the connection destination information. Note that the processing in the step S804 is a feature of the present disclosure, and hence the step S804 will be described in detail hereinafter with reference to FIG. 11. Then, in a step S805, the connection management server 400 executes connection destination information notification for notifying the connection destination information as a response to the transmission/reception processor 203. Note that processing performed according to the validity of the connection destination information will be described hereinafter with reference to FIG. 11.

Note that in the present embodiment, the information on the end points of the authentication/authorization server 300 and the resource server 350 is notified from the connection management server 400 to the MFP 200. However, the information on the end points can be notified from the authentication/authorization server 301 and the resource server 351 as a response. The storage section 204 stores the information on the end points acquired from the connection management server 400 in the server URL 209.

Next, in a step S806, a token issue request is sent from the transmission/reception processor 203 to the authentication processor 201. The token issue request in the step S806 includes the serial number of the image forming apparatus. Next, in a step S807, the authentication processor 201 transmits authentication information to the authentication/authorization server 300 to request an access token, and acquires the access token. Here, the access token is a key issued when a user uses an API. The authentication/authorization server 300 performs access token issuing processing by the authentication/authorization server section 310 to transmit the access token to the authentication processor 201 as a response in a step S808. Next, in a step S809, the authentication processor 201 notifies the acquired access token to the transmission/reception processor 203 so that the transmission/reception processor 203 acquires the access token.

Next, in a step S810, the transmission/reception processor 203 requests the resource server 350 to register a device, by using the acquired access token. Next, in a step S811, the resource server 350 requests the authentication/authorization server 300 to verify whether or not the received access token is valid. Next, in a step S812, the authentication/authorization server 300 performs the verification, and notifies a verification result to the resource server 350 in a step S813. Next, in a step S814, if the access token is valid as a result of the verification, the resource server 350 executes registration processing for providing the service. Then, the resource server 350 transmits a device registration response to the transmission/reception processor 203 in a step S815.

If it is determined in the verification in the step S812 that the access token is not valid, the resource server 350 transmits an error notification to the transmission/reception processor 203 as a response without performing registration processing. Note that although issuing and verification of the access token, which are performed by the authentication/authorization server 300, conforms to the OAuth 2.0 protocol, the verification method is not limited to the OAuth 2.0 protocol, but the verification can be performed based on Basic verification or by using a password.

Next, in a step S816, the transmission/reception processor 203 requests the resource server 350 to acquire subscription information by using the acquired access token. Next, in a step S817, the resource server 350 and the authentication/authorization server 300 performs authentication processing performed in the steps S811 to S813. Next, in a step S818, if the access token is valid, the resource server 350 transmits the subscription information to the transmission/reception processor 203 as a response. The resource server 350 determines whether or not the image forming apparatus having transmitted the subscription information acquisition request is an image forming apparatus which is the target of the consumable automatic delivery service, and transmits a result of the determination to the image forming apparatus. In an example of operations in FIG. 8, since the resource server 350 has received the subscription notification in the step S801, the resource server 350 transmits a result indicating that the subscription has been performed, to the transmission/reception processor 203 as a response in the step S818. However, in a case where the step S801 has not been executed, the resource server 350 transmits a result indicating that the subscription has not been performed to the transmission/reception processor 203 as a response in the step S818.

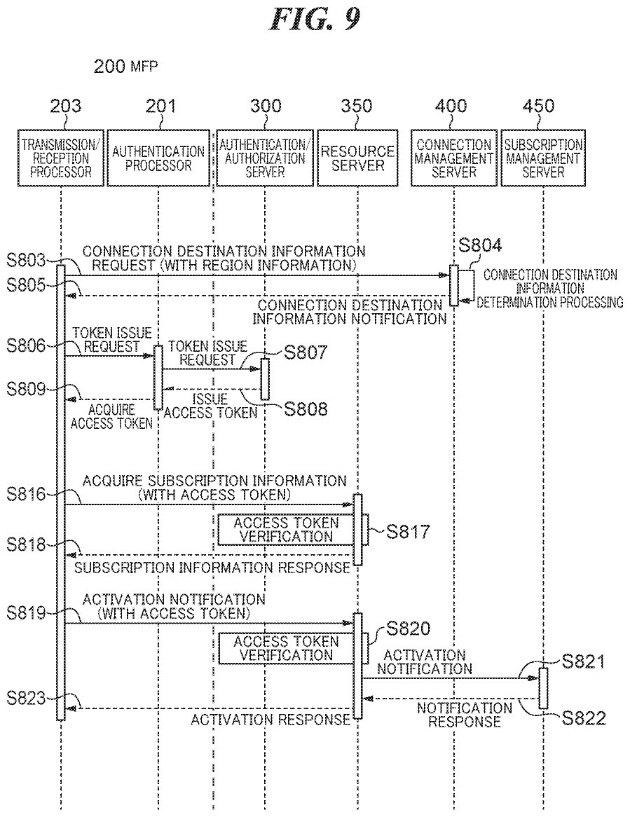

Next, in a step S819, the transmission/reception processor 203 transmits an activation notification to the resource server 350 by using the acquired access token. Note that in a case where the response indicating that the subscription has not been performed is received in the step S818, the transmission/reception processor 203 does not transmit an activation notification in the step S819. Instead, the timer counting is performed by using the timer processor 207, and after the lapse of a predetermined time period, a periodic acquisition sequence, shown in FIG. 9, is executed (as will be described hereinafter with reference to FIG. 9). Next, in a step S820, the resource server 350 and the authentication/authorization server 300 perform the authentication processing performed in the steps S811 to S813.

Next, in a step S821, if the access token is valid, the resource server 350 transmits an activation notification to the subscription management server 450. The activation notification transmitted in the step S821 is a notification for notifying the subscription management server that the function of the image forming apparatus, for notifying an event to the resource server, has been set to enabled. Next, in a step S822, a notification response is transmitted back from the subscription management server 450 to the resource server 350. Then, in a step S823, an activation response is transmitted from the resource server 350 to the transmission/reception processor 203.

Next, in a step S824, the transmission/reception processor 203 performs event transmission to the resource server 350 by using the acquired access token. The event transmission refers to transmission of consumables information to the resource server 350 in a case where there is a change in the state of consumables in the MFP 200. Specifically, an event is transmitted not only in a case where the remaining amount of a consumable becomes small or a case where a consumable is replaced, but also an event can also be transmitted when the MFP 200 is powered on or can be transmitted at a fixed period.

Next, in a step S825, the resource server 350 and the authentication/authorization server 300 perform the authentication processing performed in the steps S811 to S813. Next, in a step S826, if the access token is valid, the resource server 350 executes event data processing. Specifically, in the event data processing, the resource server 350 analyzes the consumables information transmitted from the transmission/reception processor 203, and extracts remaining amount information of the consumable to check a state of the remaining amount.

Next, in a step S827, the resource server 350 transmits a result of processing on the received event to the transmission/reception processor 203 as a response. If it is determined as a result of the event data processing in the step S826 that the remaining amount of the consumable becomes less than a predetermined threshold value, in a step S828, the resource server 350 notifies a consumable remaining amount of Low to the subscription management server 450. That is, the MFP 200 includes an event transmission section that transmits the consumables information indicating a consumed state of consumables to the resource server 350. The resource server 350 includes a trigger providing section that provides a trigger for ordering, if it is determined based on the received consumables information that the remaining amount of a consumable has become less than the predetermined threshold value, the consumable, to the subscription management server 450.

Next, in a step S829, the subscription management server 450 performs consumable order processing. By performing the order processing, the consumable is delivered to the user. Then, in a step S830, the subscription management server 450 transmits a notification response to the resource server 350. Thus, the consumable is delivered from a retailer (consumable sales company) to the user by a moving body, such as a track, in response to the consumable order processing executed by the subscription management server 450.

Further, the delivery form is not limited to delivery of consumables to a user by using a track. For example, the consumables can be delivered to a user by using an unmanned flying object, such as an autonomous drone, which can autonomously fly. The drone does not require a wireless operation instrument and is configured to receive, for example, residence address information of a user from the subscription management server 450 by wireless communication, load a consumable into the drone according to the received information, and automatically start flying to deliver the consumable to the user. This drone includes, for example, a global positioning system (GPS) device, and a controller that performs control such that latitude/longitude information indicated by the GPS device coincides with latitude/longitude information corresponding to the received residence address information. That is, the subscription management server 450 transmits the latitude/longitude information corresponding to the residence address information of the user to the drone by wireless communication. The latitude/longitude information is set as a latitude of X degrees, Y minutes, and Z seconds north (south, east, or west). Here, the value of Z is expressed to the smallest value extent (for example, up to after the decimal point) which can be detected by the GPS device. Further, the accuracy of the arrival point can be improved by installing an application for improving the accuracy of the GPS device.

The drone delivers a consumable, for example, to an entrance of a home in a case where the user resides in a detached house, and delivers, for example, to a veranda or to the vicinity of an entrance of an apartment in a case where the user resides in the apartment. Note that to load a consumable on the drone, an automatic robot to which model number information of the consumable and the like are instructed from the subscription management server 450 by wireless communication, picks up the consumable from a warehouse storing consumables and automatically loads the consumable on the drone.

Thus, the automatic delivery system is realized in which a consumable is delivered to a user, which is ordered by the consumable order processing executed by the subscription management server 450 that executes the consumable order processing, upon receipt of an order trigger from the resource server 350 that manages the devices (MFP 200). Further, the subscription management server 450 can notify by email, to a user's mobile terminal, that delivery of the consumable has been started, and an expected arrival time of the delivered object. To perform the notification, it is only required to cause a name, a residence address, an email address, and so forth, of a user to be included in the subscription information managed by the subscription management server 450. Further, the subscription management server 450 is only required to include a database that stores a position on a map and information on latitude/longitude corresponding the position, in a state associated with each other.

FIG. 9 is a sequence diagram of a state acquisition process that is periodically executed. As described above, there is a case where, after changing the setting of the consumable automatic delivery service to the activated state on the image forming apparatus, the user accesses, from a terminal, not shown, the subscription management server 450 and makes a contract. Even in such a case, to make it possible to detect that the contract has been made, the state acquisition process in FIG. 9 is periodically performed. Further, by performing the state acquisition process in FIG. 9, in a case where the user has accessed the subscription management server 450 and canceled the contract, it is also possible to detect this. The steps S803 to S809 and the steps S816 to S823 in FIG. 9 are the same as those described with reference to FIG. 8, and hence redundant description is omitted. As indicated in the steps S803 to S809, the connection destination information request and the connection destination information notification are periodically executed between the MFP 200 and the connection management server 400, and the token issue request and acquisition of the access token are periodically executed between the MFP 200 and the authentication/authorization server 300.

Further, as indicated in the steps S816 to S823, acquisition of the subscription information and the subscription information response are periodically executed between the MFP 200 and the resource server 350, and further, the activation notification, the activation response, and so forth are also executed. Then, the activation notification and the activation response are periodically executed between the resource server 350 and the subscription management server 450.

The state acquisition process periodically performed, i.e. the periodic state acquisition process is executed at a timing of the lapse of a predetermined time period in a case where the information indicating that the subscription has not been performed is transmitted from the resource server 350 to the transmission/reception processor 203 as a response in the step S818. The MFP 200 executes the periodic state acquisition process at a timing when it is determined by the timer processor 207 that the predetermined time period has elapsed. By executing the periodic state acquisition process, the MFP 200 can always have the connection destination information, the access token, the subscription information, the activate information, and so forth, which are the latest.

Further, aside from the process in FIG. 9, the configuration can be, for example, such that the resource server 350, the connection management server 400, or the like includes a periodic state acquisition section that periodically acquires a state of consumables of the MFP 200 (device). With such a configuration, it is possible to automatically detect a necessity of replacement or the like of consumables of a user's device. Note that the periodic state acquisition process can be executed at the timing when the MFP 200 is powered on or at a predetermined period.

FIG. 10 is a flowchart of a process performed in a case where the region setting is changed on the region setting screen 600. The operations of this process are realized by the CPU 111 of the MFP 200 loading a control program stored in the ROM 112 or the storage 114 into the RAM 113 and executing the loaded control program. Note that the functional sections shown in FIG. 2 each execute necessary processing using the hardware shown in FIG. 1A.

First, in a step S1001, the UI controller 208 determines whether or not the region setting has been updated. Specifically, in a case where a region has been selected, and then an OK button has been pressed on the region setting screen 600, shown in FIG. 6, it is determined that the region setting has been updated (YES), and the process proceeds to a step S1002. On the other hand, if it is determined by the UI controller 208 that the region setting has not been updated (NO), the process remains in a waiting state in the step S1001.

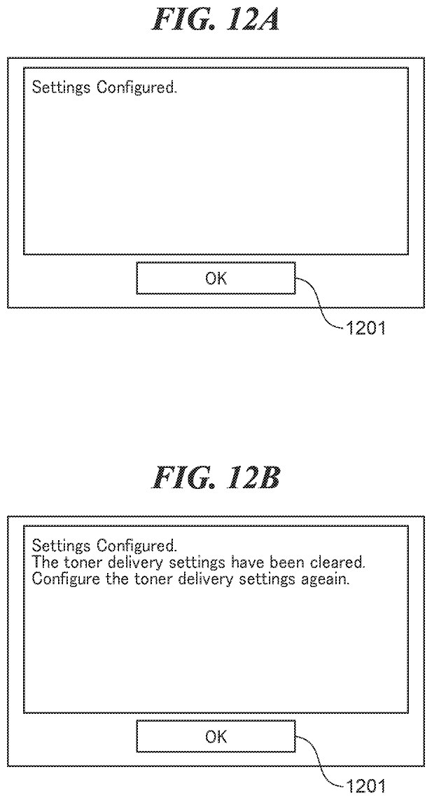

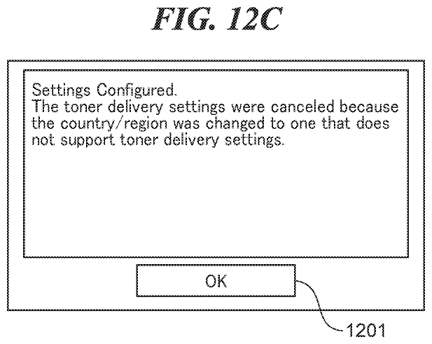

Next, in the step S1002, the storage section 204 determines whether or not the region setting has been changed between before and after the update. If it is determined by the storage section 204 that the region setting has been changed between before and after the update (YES), the process proceeds to a step S1003. On the other hand, if it is determined by the storage section 204 that the region setting has not been changed between before and after the update (the same region as set before the update has been set) (NO), the process proceeds to a step S1008, and the UI controller 208 displays an update screen. Specifically, a screen shown in FIG. 12A is displayed.

Next, in the step S1003, the storage section 204 determines whether or not the state of the toner delivery setting 501 is set to on (Activated). If it is determined by the storage section 204 that the state of the toner delivery setting 501 is set to on (YES), the storage section 204 proceeds to a step S1004 and forcibly updates the toner delivery setting 501 to off (Deactivated). On the other hand, if it is determined by the storage section 204 that the state of the toner delivery setting 501 is set to off (NO), the process proceeds to the step S1008, and the UI controller 208 displays the update screen (see FIG. 12A).

Next, in a step S1005, the storage section 204 determines whether or not the updated region is a target region supporting the consumable automatic delivery service. To determine whether or not the updated region is a target region, first, the CPU 111 reads out the support table 210 showing target regions of the consumable automatic delivery service from the storage section 204. Then, the determination is performed by comparing the region information set on the region setting screen 600 and the contents stored in the support table 210. Note that although in the present embodiment, the support table 210 is managed inside the MFP 200, the support table 210 can be acquired from an external server.

Specifically, if it is determined by the storage section 204 in the step S1005 that the newly set region is included in the country names (or region names) stored in the support table 210 (YES), it is determined that the region is a target country/region supporting the consumable automatic delivery service, and the process proceeds to a step S1006. On the other hand, if it is determined in the step S1005 that the newly set region is not included in the country names stored in the support table 210 (NO), the process proceeds to a step S1007.

In the step S1006, the UI controller 208 displays a toner delivery setting off update screen. Specifically, a screen shown in FIG. 12B is displayed. The screen shown in FIG. 12B is for notifying a user that the toner delivery setting is canceled, and the delivery setting is to be performed again. That is, the UI controller 208 can be configured to include a reconfiguration notifying section that displays, in a case where the consumable automatic delivery is forcibly switched to the deactivated state, a notification that the automatic delivery is to be set to the “activated” or “deactivated” state via a delivery setting section again.

When the user selects an OK button 1201, in a step S1009, the toner delivery-setting screen 500 is displayed on the console section 116. Although in the present embodiment, the toner delivery-setting screen 500 is displayed, reregistration processing can be performed by automatically providing a notification that the MFP 200 is to be reconnected to the resource server 350.

On the other hand, in the step S1007, the UI controller 208 displays a function deactivation update screen. Specifically, a screen shown in FIG. 17C is displayed. The function deactivation update screen is displayed to notify the user that the order is canceled because the set region is a region/country which is not supporting the consumable automatic delivery service. That is, in a case where it is determined based on the contents stored in the support table 210 that the region set through changing by the console section 116 is not a target country/region supporting the consumable automatic delivery, the CPU 111 (display notification section) displays a notification that the consumable automatic delivery is canceled, to the user.

FIG. 11 is a flowchart of the process performed according to the validity of the connection destination information. The operations of this process are realized by the CPU 131 of the connection management server 400 loading a control program stored in the ROM 132 into the RAM 133 and executing the loaded control program. This flowchart shows the details of the step S804 in FIG. 8.

First, in a step S1101, the connection destination determination section 410 of the connection management server 400 determines whether or not a connection destination information request has been received from the transmission/reception processor 203 of the MFP 200. If it is determined by the connection destination determination section 410 that the connection destination information request has been received (YES), the process proceeds to a step S1102. On the other hand, if it is determined by the connection destination determination section 410 that the connection destination information request has not been received (NO), the process remains in the waiting state in the step S1101.

Next, in the step S1102, the connection destination determination section 410 acquires the region information added to the connection destination information request when the connection destination information request was transmitted. Next, in a step S1103, the connection destination determination section 410 reads out the end point management table 700 stored and managed in the HDD 166 of the connection management server 400. Then, the connection destination determination section 410 determines whether or not the region information added to the connection destination information request when the request was transmitted exists in the Country/Region 701 in the end point management table 700.

If it is determined that the region information exists in the Country/Region 701 (YES), the connection destination determination section 410 proceeds to a step S1104. On the other hand, if it is determined that the region information does not exist in the Country/Region 701 (NO), the connection destination determination section 410 proceeds to a step S1106.

In the step S1104, the connection destination determination section 410 performs processing for setting an end point. Specifically, the connection destination information (end point) 702 in the end point management table 700 is set as response data to be notified to the transmission/reception processor 203. Then, in a step S1105, the connection destination determination section 410 transmits (responds) the connection destination information to the transmission/reception processor 203. With this, the connection destination information is stored in the storage section 204 of the MFP 200. On the other hand, in the step S1106, the connection destination determination section 410 transmits an error notification to the MFP 200. With this, it is possible to notify the user that the region information does not exist in the Country/Region 701. As described above, the connection destination determination section 410 executes the process according to the validity of the end point.

As described above, according to the embodiment of the present disclosure, the following configuration is provided. That is, the consumable automatic delivery system is configured such that the consumable automatic delivery system includes the device (MFP 200) that requires replacement of consumables and the subscription management server 450 that executes automatic order of a consumable upon receipt of an order trigger from the resource server 350 that manages the device (MFP 200). Further, for example, the device (MFP 200) includes the console section 116 used by a user to change the setting of a region, the delivery setting screen (500 and 510: delivery setting section) for setting the consumable automatic delivery to the activated or deactivated state, and the controller 110.

Then, in a case where the region setting is changed by the console section 116 in a state in which the consumable automatic delivery is set to the activated state on the delivery setting screen (500 and 510), the controller 110 forcibly switches the consumable automatic delivery setting to the deactivated state.

With this configuration, in the automatic delivery system of the present embodiment, cancellation of the toner delivery service setting and notification to the user are performed according to a change in the region setting. As a result, it is possible to obtain advantageous effects that the user can properly use the consumable automatic delivery service. Note that in a case where the setting for delivering consumables, such as toner, is “not set: deactivated” or the region setting is not changed, it is unnecessary to cancel (deactivate) the consumable delivery setting.

(1) The UI controller 208 can automatically display a screen for requesting the consumable automatic delivery service when the region setting is changed. On this screen, it is possible to change the automatic delivery setting and the like, including the contract for the delivery service. For example, on the screen shown in FIG. 12C, an object for receiving an instruction for activating the consumable automatic delivery service can be displayed. When the user selects this object, the step S803 et seq. in FIG. 8 are executed. With this, it is possible to execute the processing necessary for using the consumable automatic delivery service without a user's operation of manually displaying the screen, shown in FIG. 5, after changing the region. (2) When the region setting is changed, the consumable delivery setting can be automatically canceled, and necessary reconnection to a server can be performed. More specifically, the screen shown in FIG. 12C is displayed, and the image forming apparatus executes the step S803 et seq. With this, it is possible to perform the processing necessary for using the consumable automatic delivery service without a user's operation. (3) By providing, a GPS device or the like in a device, such as the MFP 200, when the region setting is changed, a recommended region can be displayed from a region setting list for notification to a user. Further, in doing this, an email describing a recommended region can be transmitted to a user's mobile terminal, such as a smartphone. (4) Although in the embodiment of the present disclosure, the region setting is changed by using the console section 116, the region setting can be changed from a mobile terminal different from the device. To do this, by downloading an application from a dedicated site and installing the application in the mobile terminal, it is made possible to use the method of changing the region setting. Further, to do this, the device and the mobile terminal are set enabled to perform short-range communication by Bluetooth (registered trademark) or the like. (5) By three-dimensionally displaying a variety of notifications to a user, it is made possible for the user to better understand the notifications. In doing this, the user putting on goggles or glasses for a three-dimensional image can see the variety of notifications by the three-dimensional display with the output of voices accompanying an action of an avatar created in advance. (6) The consumables are not limited to the consumables used for printing, including a toner cartridge and an ink cartridge. For example, in a case where it is required to perform replacement of a mechanical component or the like which is worn whenever used, the mechanical component or the like can be treated as a consumable.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-060949 filed Apr. 4, 2023, which is hereby incorporated by reference herein in its entirety.

What is claimed is:

1. A consumable automatic delivery system including a device that requires replacement of consumables and a subscription management server that executes automatic order processing for a consumable upon receipt of an order trigger from a resource server that manages the device, in which a consumable ordered by executing the automatic order processing is delivered to a user, comprising:
a user interface unit configured to change a setting of a region;
a delivery setting unit configured to set automatic delivery of consumables to an activated state or a deactivated state; and
a switching unit configured to switch, in a case where the setting of the region is changed by the user interface to a state in which automatic delivery of consumables has been set to the activated state by the delivery setting unit, the activated state to the deactivated state.

2. The consumable automatic delivery system according to claim 1, wherein the device includes an event transmission section that transmits consumables information indicating a consumed state of a consumable to the resource server, and
wherein the resource server includes a trigger providing section that provides, in a case where it is determined based on received consumables information that a remaining amount of a consumable becomes less than a predetermined threshold value, a trigger for ordering this consumable to the subscription management server.

3. The consumable automatic delivery system according to claim 1, wherein the device further includes a notification section that notifies, in a case where the consumable automatic delivery is switched to the deactivated state by the switching unit, the deactivated state status to a user.

4. The consumable automatic delivery system according to claim 1, wherein the device further includes a reconfiguration notifying section that displays, in a case where the consumable automatic delivery is switched to the deactivated state, a notification that the automatic delivery is to be set to the activated or the deactivated state by the delivery setting unit again.

5. The consumable automatic delivery system according to claim 1, further comprising a connection management server that manages information on end points, and
wherein the device further includes an acquisition unit configured to transmit a request for acquiring the information on an end point to the connection management server to thereby acquire the end point.

6. The consumable automatic delivery system according to claim 1, further comprising a support table storing target regions supporting the consumable automatic delivery, and
a display unit configured to display, in a case where it is determined based on contents stored in the support table that a region set by changing the setting of the region by the user interface is not a target region supporting the consumable automatic delivery, a notification that the consumable automatic delivery has been canceled, to a user.

7. The consumable automatic delivery system according to claim 1, further comprising a display unit configured to display, in a case where registration of the device in the resource server has failed, to a user a notification that a state of connection to the resource server is an unconnected state even in a state in which the consumable delivery is set to the activated state by the delivery setting unit.

8. The consumable automatic delivery system according to claim 5, wherein the connection management server includes a connection destination determination unit configured to execute, upon receipt of a request for acquiring an end point from the device, processing according to validity of the end point.

9. The consumable automatic delivery system according to claim 8, wherein the connection management server further includes an end point management table storing country names or region names and connection destination information, in a state associated with each other, and
wherein in a case where a region set by changing the setting of the region by the user interface unit is included in the end point management table, the connection destination determination unit transmits connection destination information associated with the set region, to the device, as a response.

10. The consumable automatic delivery system according to claim 8, wherein the connection management server further includes an end point management table storing country names or region names and connection destination information in a state associated with each other, and
wherein in a case where a region set by changing the setting of the region by the user interface unit is not included in the end point management table, the connection destination determination unit transmits an error notification to the device.

11. The consumable automatic delivery system according to claim 5, wherein the connection management server or the resource server further includes a periodic state acquisition unit that periodically acquires a state of consumables of a device.

12. The consumable automatic delivery system according to claim 1, wherein the device is a multifunction peripheral (MFP).

13. The consumable automatic delivery system according to claim 1, wherein the consumables are consumables used for printing, including a toner cartridge and an ink cartridge.

14. A method of controlling a consumable automatic delivery system including a device that requires replacement of consumables, and a subscription management server that executes automatic order processing for a consumable upon receipt of an order trigger from a resource server that manages the device, in which a consumable ordered by executing the automatic order processing is delivered to a user, the method comprising:
changing a setting of a region;
setting automatic delivery of consumables to an activated state or a deactivated state; and
switching, in a case where the setting of the region is changed in a state in which automatic delivery of consumables has been set to the activated state by said setting, the activated state to the deactivated state.

15. A non-transitory computer-readable storage medium storing a program for causing a computer to execute a method of controlling a consumable automatic delivery system including a device that requires replacement of consumables, and a subscription management server that executes automatic order processing for a consumable upon receipt of an order trigger from a resource server that manages the device, in which a consumable ordered by executing the automatic order processing is delivered to a user, the method comprising:
changing a setting of a region;
setting automatic delivery of consumables to an activated state or a deactivated state; and
switching, in a case where the setting of the region is changed in a state in which automatic delivery of consumables has been set to the activated state by said setting, the activated state to the deactivated state.
